(19) United States
(12) Patent Application Publication
(10) Pub. No.: US 2008/0180935 A1
(43) Pub. Date: Jul. 31, 2008

(54) RFID emergency lighting system

(76) Inventors: Mark Burdeen, Glenview, IL (US); Alfred Cantwell, Wauconda, IL (US)

Correspondence Address: LAMPEL & ASSOCIATES, P.C., 555 SKOKIE BLVD., SUITE 500, NORTHBROOK, IL, 60062, US

(21) Appl. No.: 11/657,314

(22) Filed: Jan. 25, 2007

(51) Int. Cl. F21V 19/04

(52) U.S. Cl. 362/20

(57) ABSTRACT

The present invention generally relates to an emergency lighting system which engages when a power outage occurs. The system includes a main unit which operates via AC or DC and is plugged into a wall outlet. When power is lost, the main unit is triggered and sends an RFID signal to at least one lighting fixture. The lighting fixture may be battery operated LED equipped. The battery operated lighting fixture activates the emergency lighting source when the RFID signal is received. The main unit may send the RFID signal to numerous lighting fixtures. The lighting fixtures may receive the RFID signal even if the lighting fixture is not in the direct line of sight of the main unit.

### BACKGROUND OF THE INVENTION

The present invention generally relates to an emergency lighting system which engages when a power outage occurs. The system includes a main unit which operates via AC or DC and is plugged into a wall outlet. When power is lost, the main unit is triggered and sends an RFID signal to at least one lighting fixture. The lighting fixture may be battery operated LED equipped. The battery operated lighting fixture activates the emergency lighting source when the RFID signal is received. The main unit may send the RFID signal to numerous lighting fixtures. The lighting fixtures may receive the RFID signal even if the lighting fixture is not in the direct line of sight of the main unit.

It is well known to provide emergency lighting systems in commercial and residential buildings which operate in the event of a power outage. Many of these units plug into an alternating current (AC) power line when not in use and become operational when the AC power source is interrupted for a specific period of time. When the emergency lighting system is not in use the units often recharge a battery which powers a light source when the AC power is interrupted. It is also good practice, if not required by law, to test the battery on a periodic basis.

U.S. Pat. No. 5,982,098 to Redgate discloses an uninterruptible power source for emergency lighting in an AC powered electrical system. That patent discloses using a transmitter and receiver for transmitting data signals over existing wiring to emergency wall switches interposed in the wiring for maintaining emergency lighting in the on condition when AC commercial power is interrupted and a battery powered backup unit converting DC to AC is activated upon the interruption of the commercial AC source.

Providing a backup lighting source in the event of a power loss is essential in many buildings. Many states even require a backup lighting source in certain buildings. As a result, attempts have been made to avoid the problems associated with the lights going off in a power outage that plagued many buildings in the early part of last century. Accordingly, this invention relates to a new and improved apparatus and method related for providing an automatic lighting system in the event of a power outage.

The current trend in technology and industry is to provide Radio Frequency Identification (RFID) to automatically identify and locate objects. The system can be used to relay, store and remotely retrieve data using devices called RFID tags or transponders. RFID tags are often attached to or incorporated into a product to identify the product by radio waves. The tags have recently been used to identify living organisms, such as livestock, pets and even humans. In order for the identification system to work, RFID tags generally contain silicon chips and antennas. Passive tags require no internal power source, whereas active tags require a power source.

Active tags can generally transmit data at a higher power level than passive tags. Accordingly, active tags are more suitable for use in more highly “RF challenged” environments, such as underwater or under a solid surface, such as metal. In addition, active tags can generally be detected at a much farther range than passive tags. For example, it is not uncommon for an active tag to be detectable up to one hundred meters away from the RFID reader. Because active tags require a power source, the battery associated with the active tag will eventually die. However, under certain circumstances, an active tag can have a shelf life of up to 10 years. Another advantage of active tags over passive tags is that active tags are generally capable of storing more data than passive tags. Currently, the smallest active tags are about the size of a coin and cost only a few dollars. Unlike active tags, passive tags obtain their power to activate and respond from the electronic field (radio waves) transmitted by the reader-interrogator.

Although the use of RFID tags has become increasingly more common over the years, there is no known emergency lighting system which uses RFID tags in the manner described in this invention. A need, therefore, exists for an improved emergency lighting system incorporating RFID technology to selectively turn on a lighting fixture in a power outage.

### SUMMARY OF THE INVENTION

The present invention generally relates to an emergency lighting system which engages when a power outage occurs. The system includes a main unit which operates via AC or DC and is plugged into a wall outlet. When power is lost, the main unit is triggered and sends an RFID signal to at least one lighting fixture. The lighting fixture may be battery operated LED equipped. The battery operated lighting fixture activates the emergency lighting source when the RFID signal is received. The main unit may send the RFID signal to numerous lighting fixtures. The lighting fixtures may receive the RFID signal even if the lighting fixture is not in the direct line of sight of the main unit.

The lighting system allows a single main unit plugged into a wall outlet to activate at least one emergency lighting fixture located throughout a building. In embodiments, the lighting system allows a single main unit plugged into a wall outlet to activate numerous emergency lighting fixtures. The lighting fixtures may be located in different rooms out of the line of sight of the main unit. The lighting fixtures may be preprogrammed to be activated a specified period of time after an RFID signal is received from the main unit.

The main unit of the system is powered by receiving AC power while plugged into a normal wall outlet. A typical United States wall outlet has a power source of 110-120 volts at 60 Hz. Although the occurrence of power outages in the United States is very rare compared to less developed countries, power outages still occur often in the United States. The reasons for a power failure include, for example, a defect in a power station, damage to a power line or other part of the distribution system, a short circuit, or the overloading of electricity mains.

The present invention provides an emergency lighting system which provides lighting, or otherwise power, in a power outage. The system is designed to temporarily restore light and/or power in the event of an outage. Preferably, the temporary lighting and/or power last for a few hours so that, for example, individuals located in a building will have the necessary lighting and/or power to exit a building during the interruption of the normal power supply.

As stated above, the system has a main unit which is plugged into a normal wall outlet. When this normal supply of power is interrupted by, for example, a tree falling on a power line, the main unit detects the lack of power in its circuitry and sends an RFID signal to a lighting fixture. The main unit has an RFID reader which sends a wireless transmission to an RFID tag located in at least one lighting fixture. Because this system is based on RFID transmissions, as opposed to near infrared diode technology, the lighting fixture need not be in the line of sight of the main unit. For example, many current emergency lighting systems use near infrared diode to emit a beam of light from the main unit to the lighting fixture. This light is invisible to the human eye, but carries a signal that is detectable by the lighting fixture. With this system, the main unit and lighting fixture generally must be in a direct light of site which each other. As a result, a main unit located in one room cannot activate an emergency lighting fixture located in a different room if a power outage occurs. Because of this, a building would be required to have a large number of main units to activate the large number of lighting fixtures needed to be activated in the event of a power outage. The present invention eliminates the large number of main units required by the previous systems.

In an embodiment, the emergency lighting system has a main wall unit inserted into a wall power outlet; electrical circuitry located within the main wall unit wherein the electrical circuitry is programmed to detect a stoppage in the power supply from the wall outlet; a radio frequency identification reader located within an interior of the main wall unit where the radio frequency identification reader sends a wireless signal to a lighting fixture in the event of a stoppage in the power supply from the wall power outlet; a radio frequency identification tag located within the lighting fixture; a power source electrically connected to the lighting fixture; and electrical circuitry connected to the radio frequency identification tag wherein the radio frequency identification tag sends an electric signal to the electrical circuitry to turn on the lighting fixture.

In another embodiment, the power source of the lighting fixture is a battery.

In yet another embodiment, the battery of the lighting fixture is rechargeable.

In still another embodiment, the lighting fixture is a LED light.

In yet another embodiment, the radio frequency identification reader sends the wireless signal to numerous lighting fixtures.

In still another embodiment, the lighting fixture is located outside of a direct line of sight with the main wall unit.

In an embodiment, the lighting fixture is programmed to be activated for a specified period of time.

In an embodiment, an emergency lighting system has: a main wall unit inserted into a wall power outlet; a sensor having electrical circuitry located within the main wall unit wherein the sensor detects the presence of carbon monoxide; a radio frequency identification reader located within an interior of the main wall unit where the radio frequency identification reader sends a wireless signal to a lighting fixture in the event of a specified concentration level of carbon monoxide being detected by the sensor; a radio frequency identification tag located within the lighting fixture; a power source electrically connected to the lighting fixture; and electrical circuitry connected to the radio frequency identification tag wherein the radio frequency identification tag sends an electric signal to the electrical circuitry to turn on the lighting fixture.

In an embodiment, an emergency lighting system has: a main wall unit inserted into a wall power outlet; a sensor having electrical circuitry located within the main wall unit wherein the sensor detects the presence of heat, motion or sound; a radio frequency identification reader located within an interior of the main wall unit where the radio frequency identification reader sends a wireless signal to a lighting fixture in the event of a specified occurrence of heat, motion or sound being detected by the sensor; a radio frequency identification tag located within the lighting fixture; a power source electrically connected to the lighting fixture; and electrical circuitry connected to the radio frequency identification tag wherein the radio frequency identification tag sends an electric signal to the electrical circuitry to turn on the lighting fixture.

For a more complete understanding of the above listed features and advantages of the emergency lighting system, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 illustrates a prior art backup power supply circuit.

FIG. 2 illustrates the main components of the present invention.

FIG. 3 illustrates a flow chart of the system of the invention.

FIG. 4 illustrates a second flow chart of the system of the present invention.

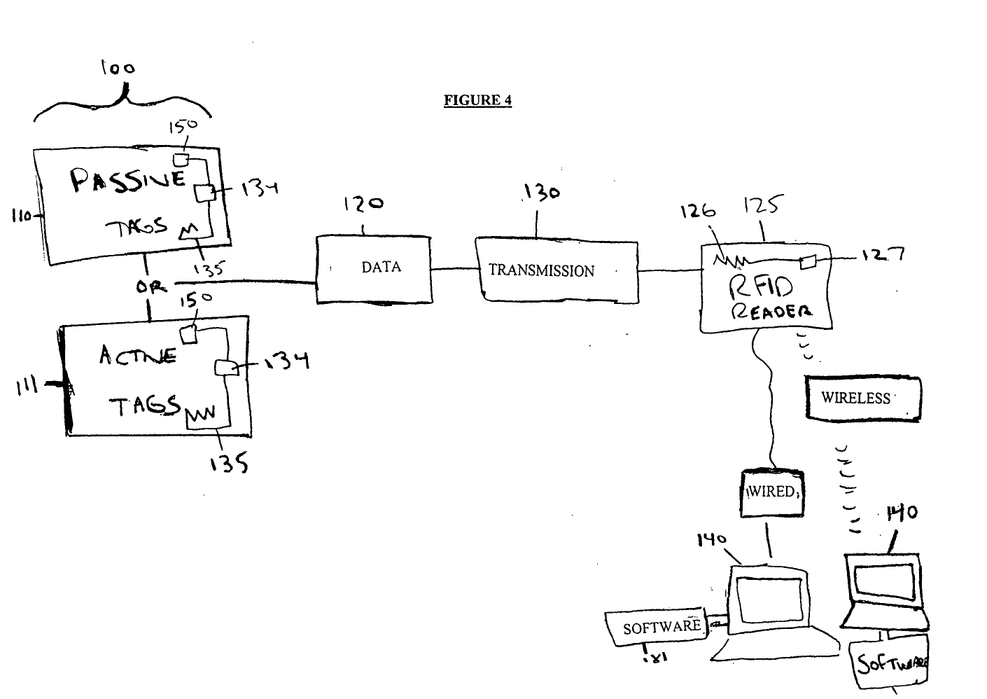

FIG. 5 illustrates the RFID system wherein a burglar alarm and/or carbon monoxide detector is implemented to activate the lighting system.

### DETAILED DESCRIPTION OF THE PREFERRED EMBODIMENTS

The present invention generally relates to an emergency lighting system which engages when a power outage occurs. The system includes a main unit which operates via AC or DC and is plugged into a wall outlet. When power is lost, the main unit is triggered and sends an RFID signal to at least one lighting fixture. The lighting fixture may be battery operated LED equipped. The battery operated lighting fixture activates the emergency lighting source when the RFID signal is received. The main unit may send the RFID signal to numerous lighting fixtures. The lighting fixtures may receive the RFID signal even if the lighting fixture is not in the direct line of sight of the main unit.

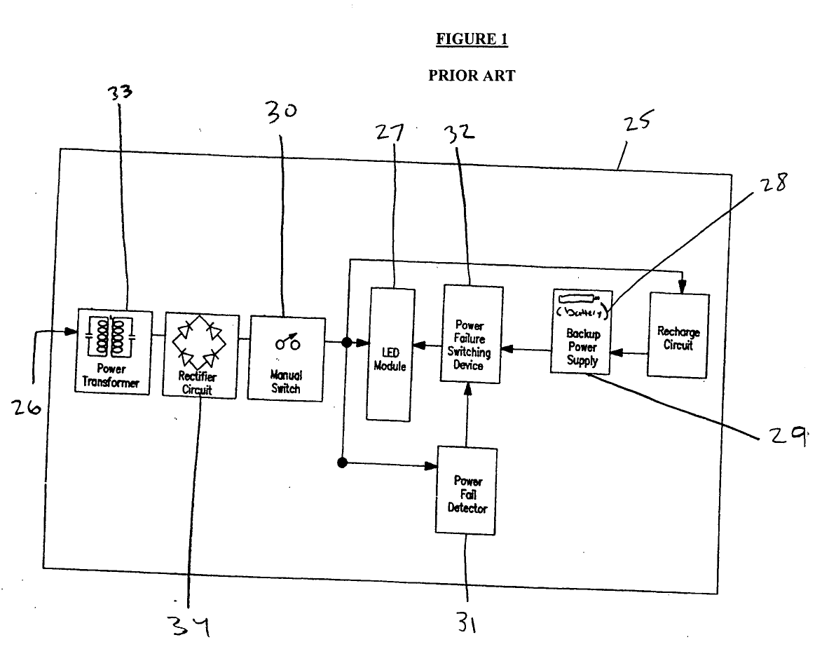

FIG. 1 illustrates an example of the prior art of a circuit diagram containing an illuminating device with a backup power supply. The backup power supply circuit 25 is connected to an external primary power source 26 that illuminates a light source 27. A battery 28 may be used as a secondary (backup) power source 29 which is also connected to the light source 27. A manual cutoff switch 30 may be located, for example, between the external primary power source 26 and the light source 27. If the manual cutoff switch 30 is switched off to disconnect the primary power source 26, the backup power supply 29 automatically becomes activated and the light source 27 remains on.

Most prior art backup power supply circuits 25 have a power fail detector 31. If the power fail detector 31 detects an absence of power from the primary power source 26, the backup system 25 becomes activated. More specifically, the power fail detector 31 signals a power failure switching device 32 which enables a current to flow from the backup power supply source 29 through the power failure switching device 32 into the light source 27. The prior art circuit illustrated in FIG. 1 also includes a power transformer 33 to accept AC voltage and step that voltage up or down, and a rectifier 34 to convert an AC current into a DC current.

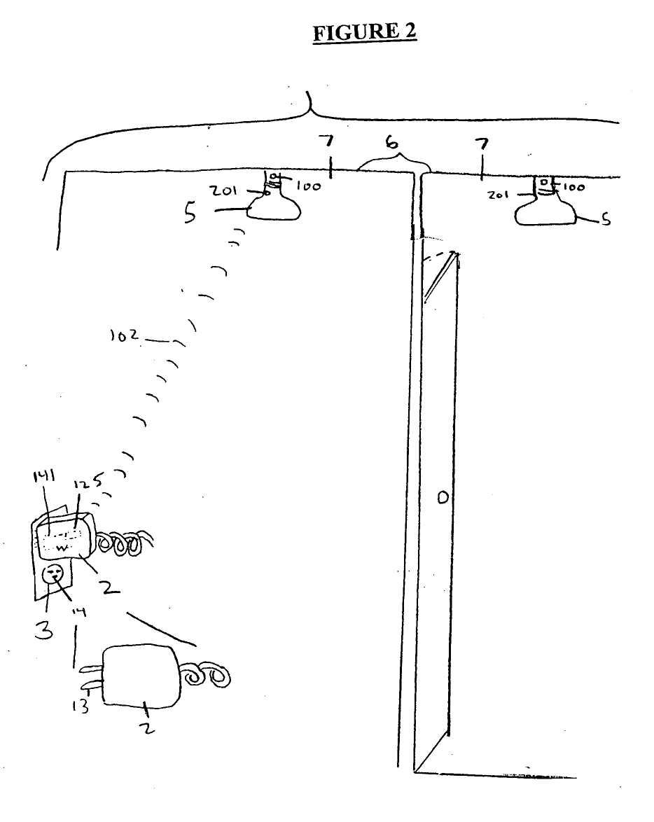

Referring now to the drawings, FIG. 2 illustrates the lighting system 1 of the present invention. The lighting system 1 allows a single main outlet unit 2 plugged into a wall outlet 3 to activate at least one emergency lighting fixture 5 located throughout a building 6. It should be noted that the single main outlet unit 2 may be programmed to active numerous emergency lighting fixtures 5. The lighting fixtures 5 may be located in different rooms 7 of the building 6, even out of the direct line of sight of the main outlet unit 2. The lighting fixtures 5 may be preprogrammed 10 to be activated a specified period of time 11 after an RFID signal 12 is received from the main outlet unit 2.

The main outlet unit 2 of the lighting system I has male electrical connectors 13 which are usually tin, brass or nickel plated. The male electrical connectors 13 connect mechanically and electronically to the female connectors 14 located in the wall outlet 3. As a result, the main outlet unit 2 is powered by receiving AC power while plugged into the wall outlet 3. A typical wall outlet has a power source of approximately 110-120 volts at 60 Hz. In addition to the male electrical connectors 13, the main outlet unit 2 of the present invention also has an RFID reader 125 (as discussed below) connected to an electrical circuit 141.

When the main outlet unit 2 detects that a power outage has occurred, the electrical circuit 141 undergoes rectification. The rectification process allows the electrical circuit 141 of the main outlet unit 2 to covert from AC power to DC power.

The current trend in technology and industry is to provide Radio Frequency Identification (RFID) to automatically identify and locate objects. The lighting system 1 of the present invention can be used to relay, store and remotely retrieve data using devices called RFID tags 100 (also called transponders). RFID tags 100 may be attached to or incorporated into the lighting fixture 5 to identify the lighting fixture 5 by radio waves 102. The RFID tags 100 may be passive tags 110 which require no internal power source or the RFID tags 100 may be active tags 111 require a power source 112. Preferably, the RFID tags 100 of the present invention are active tags 112. The RFID tags 100 of the present invention are located on or within the lighting fixtures 5 and are composed of a microchip 134 attached to an antenna 135.

The RFID system of the present invention allows data 120 to be transmitted to the RFID tag 100 by the RFID reader 125. Next, the RFID reader 125 processes the data 120 according to the desired function. The RFID system generally has a few components including the tags/transponder 100, tag reader 125, antenna 126 and interface 127. RFID technology allows a user to determine a wide variety of information from the tagged lighting fixture 5 including, the location of the lighting fixture 5. The RFID tag 100 may also be used to track moving objects, such as a battery powered light fixture 5 which may be moved from room to room in a building 6.

The RFID chip antenna 126 collects an electromagnetic wave signal 130 that is provided by the RFID reader 125 of the main outlet unit 2. The RFID tags 100 of the lighting system 1 may be manufactured to transmit at different frequencies. Typically these frequencies range from 30 KHz to nearly 1000 MHz. Most RFID tags 100 are used in the frequency range of 13.56 MHz (high frequency) or 960 MHz (ultra high frequency). The production of the electromagnetic wave signal 130 is well known in the art and will not be discussed in further detail herein.

The RFID reader 125 (also called an interrogator) detects compatible RFID tags 100 of the lighting fixtures 5 within its range. More specifically, the RFID reader 125 detects the serial number 150, or other information which identifies a specific emergency light fixture 5. The antenna 135 allows the microchip 134 to transmit the identification information to the RFID reader 125. The RFID reader 125 transmits the electromagnetic radio wave signal 130 at a set frequency, which activates the RFID tag 100 designated to receive this frequency. When the RFID tag 100 passes through the electromagnetic radio wave signal 130, it detects the RFID reader's 125 signal. The RFID reader 125 converts the electromagnetic radio wave signal 130 reflected back from the RFID tag 100 into digital information that can be then passed on to computers 140 that make use of it. If the RFID reader 125 is used to identify more than one RFID tag 100, the different electromagnetic radio wave signals 130 preferably vary enough in frequency so as to reduce or eliminate any collision in the signals, which is sometimes caused by similar radio frequency waves. The RFID reader 125 decodes the information encoded in the RFID tag's 100 integrated circuit (silicon microchip) 134 and the information is passed to a host computer 140. An application software 181 on the host computer 140 processes the information, and may perform various filtering operations to reduce the numerous often redundant reads of the same RFID tag 100 to a smaller and more useful information set.

The system is set up so that a single main outlet unit 2 may be programmed to transmit to any number of receiving light fixtures 5. Therefore, if the lights go out on, for example, the third floor of the building 6 than only the emergency light sources on that floor may be activated.

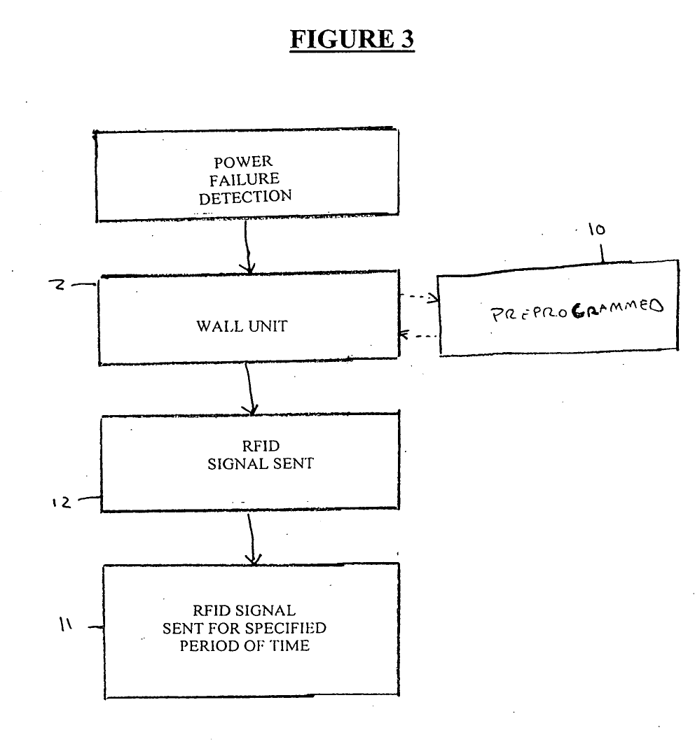

Referring now to FIG. 3, if a power outage occurs, the lighting fixture(s) 5 are may become operated by battery 201 power. Preferably, the battery power source 155 is from a small, powerful battery such as a lithium ion battery so as to reduce the required size of the lighting fixture 5 and allow the lighting fixture 5 to produce light for at least a few hours. In addition, a battery 201 should be chosen which has a long inactive shelf-life.

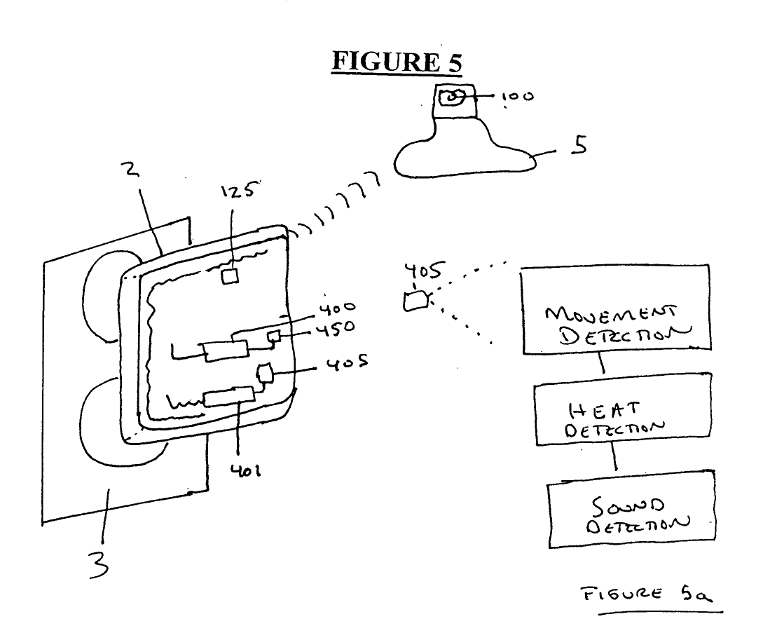

Referring now to FIG. 5, the RFID reader 125 may also trigger the RFID tag 100 to activate the lighting fixture 5 if a burglar alarm 400 and/or carbon monoxide detector 401 is triggered. For example, if a carbon monoxide detector 401 sensor 405 in the main outlet unit 2 (see FIG. 1) detects the presence of a specified level of carbon monoxide, the RFID reader 125 may send a signal 410 to the RFID tag 100. The RFID tag 100 may be attached to circuitry 411 which may activate the lighting fixture 5. As a result, an individual may be warned that there is a dangerous level of carbon monoxide present in the room when the emergency lighting fixture 5 becomes activated. In addition, the main outlet unit 2 may have a burglar alarm system 400 which has a sensor 450 for detecting, for example, movement, heat and or sound. When the burglar detector 400 becomes activated it sends a signal to the RFID reader 125 which sends a signal to the RIFD tag 100 which activates the emergency lighting fixture 5. As a result, the owner of the property may be warned that an unauthorized person has been detected. Further, activating the emergency lighting system in the event of carbon monoxide detection or the burglar alarm being activated would help warn people who are hearing impaired.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

We claim:

1) An emergency lighting system comprising:
a main wall unit inserted into a wall power outlet;
electrical circuitry located within the main wall unit wherein the electrical circuitry is programmed to detect a stoppage in the power supply from the wall outlet;
a radio frequency identification reader located within an interior of the main wall unit where the radio frequency identification reader sends a wireless signal to a lighting fixture in the event of a stoppage in the power supply from the wall power outlet;
a radio frequency identification tag located within the lighting fixture;
a power source electrically connected to the lighting fixture; and
electrical circuitry connected to the radio frequency identification tag wherein the radio frequency identification tag sends an electric signal to the electrical circuitry to turn on the lighting fixture.

2) The emergency lighting system of claim 1 wherein the power source of the lighting fixture is a battery.

3) The emergency lighting system of claim 2 wherein the battery is rechargeable.

4) The emergency lighting system of claim 1 wherein the lighting fixture is a LED light.

5) The emergency lighting system of claim 1 wherein the radio frequency identification reader sends the wireless signal to numerous lighting fixtures.

6) The emergency lighting system of claim 1 wherein the lighting fixture is located outside of a direct line of sight with the main wall unit.

7) The emergency lighting system of claim 1 wherein the lighting fixture is programmed to be activated for a specified period of time.

8) An emergency lighting system comprising:
a main wall unit inserted into a wall power outlet;
a sensor having electrical circuitry located within the main wall unit wherein the sensor detects the presence of carbon monoxide;
a radio frequency identification reader located within an interior of the main wall unit where the radio frequency identification reader sends a wireless signal to a lighting fixture in the event of a specified concentration level of carbon monoxide being detected by the sensor;
a radio frequency identification tag located within the lighting fixture;
a power source electrically connected to the lighting fixture; and
electrical circuitry connected to the radio frequency identification tag wherein the radio frequency identification tag sends an electric signal to the electrical circuitry to turn on the lighting fixture.

9) An emergency lighting system comprising:
a main wall unit inserted into a wall power outlet;
a sensor having electrical circuitry located within the main wall unit wherein the sensor detects the presence of heat, motion or sound;
a radio frequency identification reader located within an interior of the main wall unit where the radio frequency identification reader sends a wireless signal to a lighting fixture in the event of a specified occurrence of heat, motion or sound being detected by the sensor;
a radio frequency identification tag located within the lighting fixture;
a power source electrically connected to the lighting fixture; and
electrical circuitry connected to the radio frequency identification tag wherein the radio frequency identification tag sends an electric signal to the electrical circuitry to turn on the lighting fixture.
